(19) United States
(12) Patent Application Publication
(10) Pub. No.: US 2019/0351877 A1
(43) Pub. Date: Nov. 21, 2019

(54) WINDSCREEN WIPER DEVICE

(71) Applicant: FEDERAL-MOGUL S.A., Aubange (BE)

(72) Inventor: Xavier Boland, Arlon (BE)

(21) Appl. No.: 16/463,389

(22) PCT Filed: Nov. 23, 2016
(86) PCT No.: PCT/EP2016/078541

§ 371 Date: May 23, 2019

(51) Int. Cl. B60S 1/38

(52) U.S. Cl. CPC B60S 1/3808; B60S 1/3887; B60S 1/3877

(57) ABSTRACT

A windscreen wiper device of the flat blade type comprising an elastic, elongated carrier element, as well as an elongated wiper blade of a flexible material, which can be placed in abutment with a windscreen to be wiped, which wiper blade includes a central longitudinal groove, in which groove a central longitudinal strip of the carrier element is disposed. The windscreen wiper device comprises a connecting device for an oscillating wiper arm, wherein at least one end of the wiper blade extends beyond the longitudinal strip in order to define a space open at one end thereof. The wiper blade comprises a spoiler at a side thereof facing away from a windscreen to be wiped, with the special feature that an end piece is provided at the end of the wiper blade. The end piece comprises a plug fitted inside the space in order to dust and water tightly close the groove at the end of the wiper blade, as well as retaining means fitted outside the space and into a longitudinal slit on a longitudinal side of the wiper blade in order to retain the end piece onto the wiper blade, and wherein an extremity of the spoiler is unengaged by the end piece near the end of the wiper blade.

### TECHNICAL FIELD

The present invention relates to a windscreen wiper device of the flat blade type comprising an elastic, elongated carrier element, as well as an elongated wiper blade of a flexible material, which can be placed in abutment with a windscreen to be wiped, which wiper blade includes a central longitudinal groove, in which groove a central longitudinal strip of the carrier element is disposed, which windscreen wiper device comprises a connecting device for an oscillating wiper atm, wherein at least one end of the wiper blade extends beyond the longitudinal strip in order to define at the end of the wiper blade a space open at one end thereof, the wiper blade comprising a spoiler at a side thereof facing away from a windscreen to be wiped.

### BACKGROUND OF THE INVENTION

In the framework of the present invention the oscillating arm near one end thereof in use is pivotally connected to the wiper blade with the help of the connecting device and near the other end thereof is connected to a mounting head on a drive shaft for transferring a reciprocal movement to the wiper blade. In the invention the wiper blade and the spoiler are preferably made in one piece of material, more preferably through extrusion.

The longitudinal strip is also called a “flexor”, while the connecting device is also indicated as a “connector”. The connector is particularly made in one piece of plastic.

Such a windscreen wiper device is generally known. The prior art windscreen wiper device is in particular designed as a “yokeless” wiper device, wherein use is no longer made of several yokes pivotally connected to each other, but wherein the wiper blade is biased by the carrier element, as a result of which it exhibits a specific curvature. According to the prior art end caps are slided over outer ends of the wiper blade.

One drawback of the prior art windscreen wiper device is the fact that the end caps and the wiper blade are not connected in a durable, solid manner, so that the connecting pieces may come loose from the wiper blade. As a result, the life span of the prior art windscreen wiper device may be seriously shortened.

### SUMMARY OF THE INVENTION

The object of the invention is to overcome this drawback of the prior art as indicated above.

In order to accomplish that objective, a windscreen wiper device of the kind referred to in the introduction is characterized according to the invention in that an end piece is provided at the end of the wiper blade, wherein the end piece comprises a plug fitted inside the space in order to dust and water tightly close the groove at the end of the wiper blade, as well as retaining means fitted outside the space and into a longitudinal slit on a longitudinal side of the wiper blade in order to retain the end piece onto the wiper blade, and wherein an extremity of the spoiler is unengaged by the end piece near the end of the wiper blade.

In other words, the wiper blade including its central longitudinal groove is longer (has a larger length) than the longitudinal strip, wherein the central longitudinal groove with the longitudinal strip inserted therein thus defines one blind hole at one (outer) end of the wiper blade or preferably two blind holes at both (outer) ends of the wiper blade. During assembly of the present windscreen wiper device the end piece(s) and the wiper blade is/are interconnected in such a way that the groove is locked from the outside (i.e. the environment) in order to prevent dust and water entering the groove from the outside. The retaining means ensure that the end pieces will stay on the free ends of the wiper blade at all times. As the end piece does not engage the extremity of the spoiler, the spoiler is left free, i.e. uncovered, at that location, so that the spoiler is free to move under the influence of a wind load. Hence, the wiping properties are improved.

The longitudinal slit is preferably located between the central longitudinal groove and a tilting web of the wiper blade carrying a wiping lip thereof, seen in a direction perpendicular to a windscreen to be wiped.

Preferably, the end piece has a maximum width corresponding to a maximum width of the groove. More preferably, the end piece has a maximum height corresponding to the sum of a maximum height of the groove, a height of the longitudinal slit and a thickness a bottom wall of the groove.

As the end pieces close the groove in a dust tight and watertight manner, dust and (rain) water are not allowed to enter the groove. This implies that any decrease in mobility between the wiper blade and the strip due to any dust inside the groove is avoided, whereas any corrosion of the strip due to any (rain) water inside the groove is avoided as well.

In one preferred embodiment of a windscreen wiper device in accordance with the invention the plug and the retaining means are made in one piece, preferably one piece of plastic material.

In another preferred embodiment of a windscreen wiper device according to the invention the retaining means comprises at least one longitudinal finger provided in the longitudinal slit on the longitudinal side of the wiper blade. Particularly, by sliding the plug into the respective blind holes of the wiper blade at one outer end thereof, the longitudinal finger is simultaneously slid into the longitudinal slit.

In another preferred embodiment of a windscreen wiper device in accordance with the longitudinal finger is provided with teeth engaging a wall of the longitudinal slit. Particularly, the longitudinal finger is provided with upwardly extending teeth engaging an upper wall of the longitudinal slit formed by a bottom wall of the groove. An intermediate web of the wiper blade as defined by the longitudinal slit or opposing longitudinal slits is thus left unharmed.

In another preferred embodiment of a windscreen wiper device according to the invention the retaining means comprises two longitudinal fingers provided into opposing longitudinal slits on longitudinal sides of the wiper blade. The longitudinal slits are preferably located between the central longitudinal groove and a tilting web of the wiper blade carrying a wiping lip thereof, seen in a direction perpendicular to a windscreen to be wiped.

The present invention also relates to an end piece as a single constructional element, i.e. an end piece arranged to be provided at an end of a wiper blade of the flat blade type comprising a spoiler at a side thereof facing away from a windscreen to be wiped, as well as a central longitudinal groove accommodating a central longitudinal strip of a carrier element, at least one end of the wiper blade extending beyond the longitudinal strip in order to define at the end of the wiper blade a space open at one end thereof, wherein the end piece comprises a plug arranged to be fitted inside the space in order to dust and water tightly close the groove at the end of the wiper blade, as well as retaining means arranged to be fitted outside the space and into a longitudinal slit on a longitudinal side of the wiper blade in order to retain the end piece onto the wiper blade, while an extremity of the spoiler is unengaged by the end piece near the end of the wiper blade.

### BRIEF DESCRIPTION OF TH E DRAWINGS

The invention will now be explained in more detail with reference to figures illustrated in a drawing, wherein:

FIG. 1 is a perspective, schematic view of a windscreen wiper device according to the prior art;

FIG. 2 shows several views, some partially cut open, of a windscreen wiper device according to the present invention, wherein an end piece in a perspective view is shown cooperating with a wiper blade of FIG. 1; and

FIG. 3 refers to a detail of a wiper blade of FIG. 2 with the end piece in mounted position, partly cut open along a vertical plane perpendicular to a windscreen to be wiped.

### DETAILED DESCRIPTION OF THE PREFERRED EMBODIMENTS

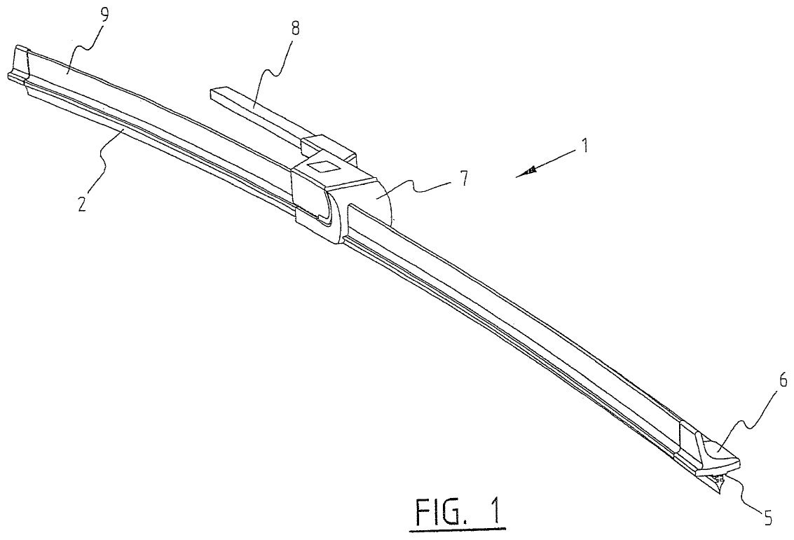

FIG. 1 shows a windscreen wiper device 1 according to the prior art. The windscreen wiper device is built up of an elastomeric wiper blade 2 having a central longitudinal groove 3. A central longitudinal strip 4 made of spring band steel is fitted in the longitudinal groove 3. The strip 4 forms a flexible carrier element for the rubber wiper blade 2, as it were, which is thus biased in a curved position (the curvature in operative position being that of a windscreen to be wiped). At both ends 5 of the wiper blade 2, that is on either side of the windscreen wiper device 1, end caps 6 are povided. The windscreen wiper device 1 is further equipped with a connecting device 7 for an oscillating arm 8, and a spoiler 9.

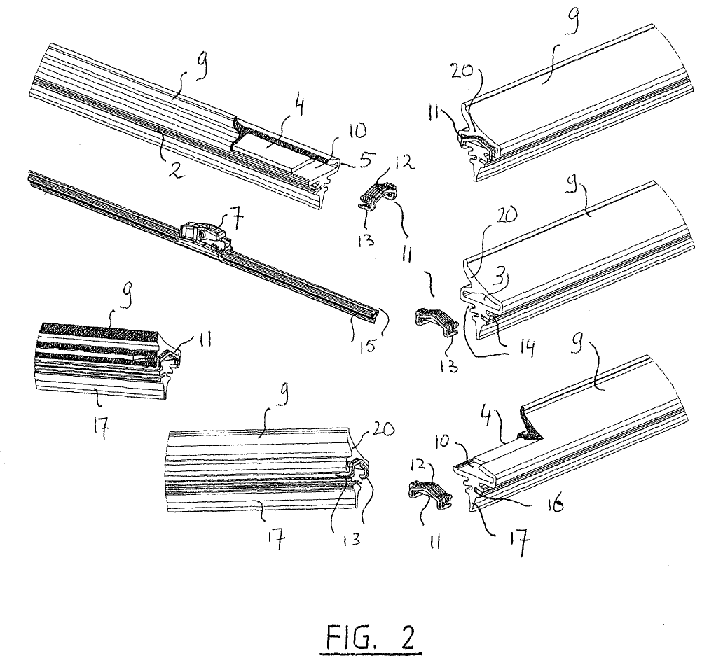

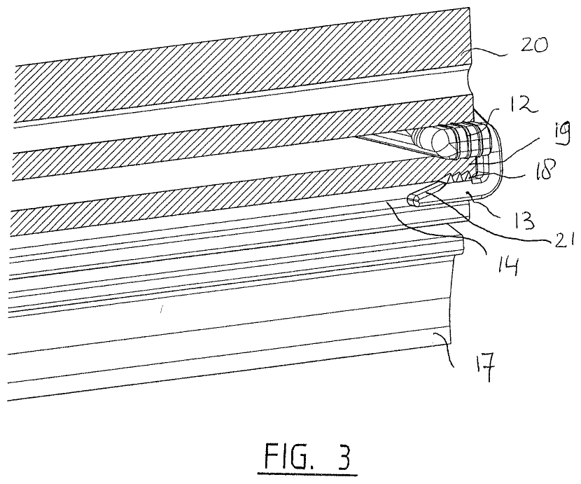

With reference to FIGS. 2 and 3, the longitudinal strip 4 is inserted inside the longitudinal groove 3 of the wiper blade 2 until at both ends 5 of the wiper blade 2 a blind hole 10 is formed. Indeed, as the wiper blade 2 and the groove 3 are longer than the strip 4, at both ends 5 of the wiper blade 2 the blind hole 10 (that is a space open at one end) is created. In the embodiment of FIGS. 2 and 3 no longer use is made of the end caps 6 of FIG. 1, but instead end pieces 11 according to the invention are used at both ends 5.

The end pieces 11 are each made of one piece of plastic and each comprise a plug 12 fitted inside the space, or blind hole, 10 in order to dust and water tightly close the groove 3 at the respective end 5 of the wiper blade 2. Further, each end piece 11 comprises two longitudinal fingers 13 provided into opposing longitudinal slits 14 on longitudinal sides 15 of the wiper blade 2. As shown, the longitudinal slits 14 are located between the central longitudinal groove 3 and a tilting web 16 of the wiper blade 2 carrying a wiping lip 17 thereof. The longitudinal fingers 13 serve as retaining means for retaining the end pieces 11 onto the wiper blade 2. Thereto, the longitudinal fingers 13 are each provided with upwardly extending teeth 18 engaging an upper wall 19 of each longitudinal slit 14 formed by a bottom wall of the groove 3 (see FIG. 3). By slightly over-dimensioning, or over-sizing, the plug 12 relative to the blind hole 10, the upper wall 19 is slightly pressed outwards upon inserting the plug 12 therein, so that the teeth 18 would penetrate the upper wall 19 in a firm manner, without damaging the latter, in order to reliably retain the respective end piece 11 onto the wiper blade 2. As shown in FIGS. 2 and 3, an extremity 20 of the spoiler 9 is left uncovered by the end piece 11 near the end 5 of the wiper blade 2. The longitudinal fingers 13 may have inclined or beveled free ends 21 in order to facilitate insertion thereof in the longitudinal slits 14.

The present invention is not limited to the embodiment shown, but extends also to other embodiments falling within the scope of the appended claims.

1. A windscreen wiper device (1) of the flat blade type comprising an elastic, elongated carrier element, as well as an elongated wiper blade (2) of a flexible material, which can be placed in abutment with a windscreen to be wiped, which wiper blade (2) includes a central longitudinal groove (3), in which groove (3) a central longitudinal strip (4) of the carrier element is disposed, which windscreen wiper device (1) comprises a connecting device (7) for an oscillating wiper arm (8), wherein at least one end (5) of said wiper blade (2) extends beyond said longitudinal strip (4) in order to define at said end of said wiper blade (2) a space (10) open at one end thereof, said wiper blade (2) comprising a spoiler (9) at a side thereof facing away from a windscreen to be wiped, characterized in that an end piece (11) is provided at said end (5) of said wiper blade (2), wherein said end piece (11) comprises a plug (12) fitted inside said space (10) in order to dust and water tightly close said groove (3) at said end (5) of said wiper blade (2), as well as retaining means fitted outside said space (10) and into a longitudinal slit (14) on a longitudinal side (15) of said wiper blade (2) in order to retain said end piece (11) onto said wiper blade (2), and wherein an extremity (20) of said spoiler (9) is unengaged by said end piece (11) near said end (5) of said wiper blade (2).

2. A windscreen wiper device (1) according to claim 1, wherein said end piece (11) has a maximum width corresponding to a maximum width of said groove (3).

3. A windscreen wiper device (1) according to claim 1 or 2, wherein said end piece (11) has a maximum height corresponding to the sum of a maximum height of said groove (3), a height of said longitudinal slit (14) and a thickness a bottom wall of said groove (3).

4. A windscreen wiper device (1) according to claim 3, wherein said plug (11) and said retaining means are made in one piece.

5. A windscreen wiper device (1) according to claim 4, wherein said plug (6) and said retaining means are made in one piece of plastic material.

6. A windscreen wiper device (1) according to claim 1, wherein said retaining means comprises at least one longitudinal finger (13) provided in said longitudinal slit (14) on said longitudinal side (15) of said wiper blade (2).

7. A windscreen wiper device (1) according to claim 6, wherein said longitudinal finger (13) is provided with teeth (18) engaging a wall (19) of said longitudinal slit (14).

8. A windscreen wiper device (1) according to claim 7, wherein said longitudinal finger (13) is provided with upwardly extending teeth (18) engaging an upper wall (19) of said longitudinal slit (14) formed by a bottom wall of said groove (3).

9. A windscreen wiper device (1) according to claim 1, wherein said retaining means comprises two longitudinal fingers (13) provided into opposing longitudinal slits (14) on longitudinal sides (15) of said wiper blade (2).

10. A windscreen wiper device (1) according to claim 9, wherein said longitudinal slits (14) are located between said central longitudinal groove (3) and a tilting web (16) of said wiper blade (2) carrying a wiping lip (17) thereof.

11. An end piece (11) as a single constructional element arranged to be used in a windscreen wiper device (1) according to any one of the preceding claims 1 through 10.
